(19) United States
(12) Patent Application Publication
(10) Pub. No.: US 2026/0011908 A1
(43) Pub. Date: Jan. 8, 2026

(54) ANTENNA SYSTEM AND ELECTRONIC DEVICE

(71) Applicant: Honor Device Co., Ltd., Shenzhen (CN)

(72) Inventors: Xiaoyong DONG, Shenzhen (CN); Jin DONG, Shenzhen (CN); Hui YU, Shenzhen (CN); Yuzhan LI, Shenzhen (CN)

(73) Assignee: Honor Device Co., Ltd., Shenzhen (CN)

(21) Appl. No.: 18/992,865

(22) PCT Filed: Nov. 27, 2023
(86) PCT No.: PCT/CN2023/134361

§ 371 Date: Jan. 9, 2025

(30) Foreign Application Priority Data
Feb. 16, 2023 (CN) 202310144912.5

(51) Int. Cl. H01Q 1/22; H01Q 5/20; H01Q 5/30

(52) U.S. Cl. CPC H01Q 1/2291; H01Q 1/22; H01Q 5/20; H01Q 5/30

(57) ABSTRACT

Embodiments of this application disclose an antenna system and an electronic device. The antenna system includes one NFC antenna and N conventional antennas, and each of the N conventional antennas includes a feed point, a grounding point, and a radiating branch. M conventional antennas in the N conventional antennas include blocking devices. An i^{th} antenna includes an i^{th} radiating branch, an i^{th} feed point, an i^{th} blocking device, and an i^{th} grounding point, the i^{th} radiating branch is coupled to the i^{th} feed point, and the i^{th} radiating branch is coupled to the i^{th} grounding point through the i^{th} blocking device. The blocking device is configured to block a radio frequency signal in a frequency band of the NFC antenna in the M conventional antennas. The M conventional antennas are within a field strength range of radiation of the NFC antenna. Radiation performance of the NFC antenna is improved.

### CROSS-REFERECNE TO RELATED APPLICATIONS

This application is a national stage of International Application No. PCT/CN2023/134361, filed on Nov. 27, 2023, which claims priority to Chinese Patent Application No. 202310144912.5, filed on Feb. 16, 2023. Both of the aforementioned applications are hereby incorporated by reference in their entireties.

### TECHNICAL FIELD

This application relates to the field of wireless communication technologies, and in particular, to an antenna system and an electronic device.

### BACKGROUND

As mobile phones continue to develop, bodies of the mobile phones become thinner and lighter, and thicknesses also become thinner. This means assembling space for various modules inside the mobile phones is very limited. Electronic devices need to communicate through various antennas. Space left for antenna radiators in assembling of the electronic devices is very limited, and as a consequence, sizes of NFC antennas become smaller. In addition, much metal device interference exists around the NFC antennas, resulting in poor radiation effects of the NFC antennas.

### SUMMARY

Embodiments of this application disclose an antenna system and an electronic device, to improve a radiation effect of an NFC antenna.

According to a first aspect, this application provides an antenna system, where the antenna system includes one near field communication (NFC) antenna and N conventional antennas, and each of the N conventional antennas includes a feed point, a grounding point, and a radiating branch, M conventional antennas in the N conventional antennas include blocking devices, an i^{th} antenna includes an i^{th} radiating branch, an i^{th} feed point, an i^{th} blocking device, and an i^{th} grounding point, the i^{th} radiating branch is coupled to the i^{th} feed point, the i^{th} radiating branch is coupled to the i^{th} grounding point through the i^{th} blocking device, and the i^{th} antenna is any one of the M conventional antennas. The blocking device is configured to block a radio frequency signal in a frequency band of the NFC antenna in the M conventional antennas, and N is an integer greater than or equal to M, and M is a positive integer. In an operating process of the NFC antenna, the M conventional antennas are within a field strength range of radiation of the NFC antenna.

In this embodiment of this application, during assembling of the antenna system in an electronic device, space is limited, and an assembled device is complex. As a result, interference to the NFC antenna exists. In this solution, a gap distance L exists between the NFC antenna and each of the M conventional antennas. Because a frequency range difference between the NFC antenna and the conventional antenna is relatively large, for the conventional antenna with a high-frequency radio frequency range, the blocking device can isolate or block a signal in a radio frequency range of the NFC antenna, so that signal communication in only an operating frequency band of the conventional antenna is ensured. The M conventional antennas can receive a radio frequency signal in the operating frequency band of the NFC antenna, and the blocking device can prevent the radio frequency signal in the operating frequency band of the NFC antenna from leaking to a ground, so that a reduction in signal radiation strength is avoided. In this way, a grounding terminal of the conventional antenna can prevent radiation energy of the NFC antenna from leaking to the ground, so that a radiation effect of the NFC antenna can be improved, and interference between antennas is reduced. In addition, because a received radiation signal in the operating frequency band of the NFC antenna in the conventional antenna does not leak to a ground, the conventional antenna in another frequency band performs secondary radiation on the NFC frequency band signal, which is equivalent to increasing a lateral width of an NFC antenna radiator, and to increasing an area of the NFC antenna. In this way, a radiation blind region of the NFC antenna is reduced, and an NFC card swiping success rate is increased.

In a possible implementation, a gap distance L exists between the NFC antenna and the M conventional antennas, L is a shortest spatial distance between antenna radiators in the M conventional antennas and the radiator of the NFC antenna, and a gap distance between the i^{th} antenna and the NFC antenna is an i^{th} distance lᵢ.

A gap exists between adjacent antennas in the M conventional antennas.

In this embodiment of this application, the gap distance L exists between the NFC antenna and each of the M conventional antennas, and because when the gap distance L between the NFC antenna and each of the M conventional antennas is relatively small, interference between the NFC antenna and each of the M conventional antennas can be reduced by using the blocking device, performance of the NFC antenna is improved.

In a possible implementation, a range of L is 0.2 mm to 10 mm.

In this embodiment of this application, the range of L is 0.2 mm to 10 mm, so that it is ensured that mutual interference between each of the M conventional antennas and the NFC antenna of the electronic device is reduced when each of the M conventional antennas is assembled at a position relatively close to the NFC antenna, that is, when space usage efficiency of inner space of the electronic device is high. In other words, a distance (over 0.2 mm) needs to be maintained between the NFC antenna and each of the M conventional antennas, to ensure a radiation effect of the conventional antenna. In addition, the distance between the NFC antenna and each of the M conventional antennas cannot be too far. When the distance is too far, radiation performance of the NFC antenna is hardly affected, and a radiation improvement effect of the blocking device is not obvious.

In a possible implementation, the blocking device includes one or more of a capacitor, a band-pass circuit, a band-stop circuit, and a high-pass filter.

The blocking device may include only a capacitor, only a band-pass circuit, only a band-stop circuit, or only a high-pass filter. Alternatively, the blocking device may include a capacitor and a band-pass circuit, a capacitor and a band-stop circuit, a band-pass circuit and a band-stop circuit, a capacitor and a high-pass filter, a band-pass circuit and a high-pass filter, or a band-stop circuit and a high-pass filter. Alternatively, the blocking device may include a capacitor, a band-pass circuit, and a band-stop circuit, include a band-pass circuit, a band-stop circuit, and a high-pass filter, include a capacitor, a band-stop circuit, and a high-pass filter, or include a capacitor, a band-pass circuit, and a high-pass filter. All manners of combination are not limited in this application.

In this embodiment of this application, the blocking device is configured to block a radio frequency signal that is in an NFC antenna frequency band and that is generated in the M conventional antennas. The M conventional antennas can receive the radio frequency signal in the operating frequency band of the NFC antenna, and the blocking device can prevent the radio frequency signal in the operating frequency band of the NFC antenna from leaking to the ground, so that a reduction in signal radiation strength is avoided. This improves a radiation effect of the NFC antenna. Therefore, a specific form of the blocking device is not limited.

In a possible implementation, when the blocking device is a capacitor, a capacitance range of the capacitor is 1 pF to 10 nF.

In this embodiment of this application, the blocking device is configured to block the radio frequency signal that is in the NFC antenna frequency band and that is generated in the M conventional antennas. The M conventional antennas can receive the radio frequency signal in the operating frequency band of the NFC antenna, and the blocking device can prevent the radio frequency signal in the operating frequency band of the NFC antenna from leaking to the ground, so that a reduction in signal radiation strength is avoided. Therefore, when the blocking device is a capacitor, a blocking degree of the NFC frequency band signal is related to capacitance of the capacitor. Based on specific experimental simulation, it is found that a radiation effect of the NFC antenna is better when a capacitance range is 1 pF to 10 nF.

In a possible implementation, when an operating frequency band of the i^{th} antenna is above 2.4 GHz, a capacitance range of an i^{th} capacitor is above 3 pF: when an operating frequency band of the i^{th} antenna is 1.7 GHz to 2.4 GHz, a capacitance range of an i^{th} capacitor is above 10 pF: or when an operating frequency band of the i^{th} antenna is 700 MHz to 900 MHz, a capacitance range of an i^{th} capacitor is above 33 pF. The i^{th} capacitor is the i^{th} blocking device.

In this embodiment of this application, operating frequency bands of the conventional antennas are different. When the blocking device is a capacitor, a radiation effect of the NFC antenna can be better only when capacitance of the capacitor matches the operating frequency band.

In a possible implementation, when the i^{th} blocking device is a band-pass circuit, the band-pass circuit allows a signal in a frequency band above 500 MHz to pass through.

In this embodiment of this application, the operating frequency band of the conventional antenna is usually 700 MHz. Therefore, a basic requirement of the blocking device is to allow a high-frequency signal to pass through and block a low-frequency signal, and a band-pass frequency band above 500 MHz is also relatively appropriate. This can ensure normal communication of a conventional antenna signal and improve a radiation effect of the NFC antenna.

In a possible implementation, when the i^{th} blocking device is a high-pass filter, the high-pass filter allows a signal in a frequency band above 500 MHz to pass through.

In this embodiment of this application, the operating frequency band of the conventional antenna is usually 700 MHz. Therefore, a basic requirement of the blocking device is to allow a high-frequency signal to pass through and block a low-frequency signal, and a band-pass frequency band above 500 MHz is also relatively appropriate. This can ensure normal communication of a conventional antenna signal and improve a radiation effect of the NFC antenna.

In a possible implementation, when M is 4, the M conventional antennas include a first antenna, a second antenna, a third antenna, and a sixth antenna, an operating frequency band of the first antenna is 2.4 GHz to 2.5 GHz, an operating frequency band of the second antenna is 5 GHz, an operating frequency band of the third antenna is 703 MHz to 960 MHz, and an operating frequency band of the sixth antenna is 1.7 GHz to 3.8 GHz.

In this embodiment of this application, the operating frequency band of the conventional antenna is usually used for mobile communication, and the operating frequency band of the conventional antenna may be within the foregoing range, so that normal communication of the electronic device is ensured.

According to a second aspect, this application provides an electronic device, where the electronic device includes the antenna system in the first aspect.

### BRIEF DESCRIPTION OF DRAWINGS

FIG. 1A and FIG. 1B are schematic diagrams of a structure of a foldable electronic device 100 according to an embodiment of this application:

FIG. 2 is a schematic diagram of a structure of a functional module of an electronic device 100 according to an embodiment of this application:

FIG. 3 is another schematic diagram of a structure of a foldable electronic device 100 according to an embodiment of this application:

FIG. 4 is a schematic exploded diagram of a structure of an electronic device 100 according to an embodiment of this application:

FIG. 5A to FIG. 5D are schematic exploded programs of antenna position relationships of an electronic device 100 according to an embodiment of this application:

FIG. 6A to FIG. 6C are schematic diagrams of a group of position relationships between a conventional antenna 20× and an NFC antenna 24 according to an embodiment of this application;

FIG. 7A and FIG. 7B are schematic diagrams of a group of connection structures of a conventional antenna and an NFC antenna according to an embodiment of this application;

FIG. 8A is a schematic diagram of a structure of a band-pass circuit according to an embodiment of this application;

FIG. 8B is a schematic diagram of a structure of a band-stop circuit according to an embodiment of this application;

FIG. 8C is a schematic diagram of a structure of a high-pass filter according to an embodiment of this application;

FIG. 9A to FIG. 9G are schematic diagrams of a group of simulation results of an NFC antenna and a conventional antenna according to an embodiment of this application;

FIG. 10 is a schematic diagram of an electric field result of an NFC antenna and a conventional antenna according to an embodiment of this application; and

FIG. 11 is a schematic diagram of a simulation structure of an NFC antenna and a conventional antenna according to an embodiment of this application.

### REFERENCE NUMERALS OF MAIN ELEMENTS

| | |
|---|---|
| Electronic device | 100 |
| First body | 11 |
| Second body | 12 |
| Connecting portion | 13 |
| Display | 14 |
| First display | 141 |
| Second display | 142 |
| Antenna system | 200 |
| Antenna | 20 |
| First antenna | 21 |
| First radiating branch | 211 |
| First feed point | 212 |
| First grounding point | 213 |
| First blocking device | 214 |
| Second antenna | 22 |
| Second radiating branch | 221 |
| Second feed point | 222 |
| Second grounding point | 223 |
| Second blocking device | 224 |
| Third antenna | 23 |
| Third radiating branch | 231 |
| Third feed point | 232 |
| Third grounding point | 233 |
| Third blocking device | 234 |
| NFC antenna | 24 |
| Fourth radiating branch | 241 |
| Fourth feed point | 242 |
| Fourth grounding point | 243 |
| Sixth antenna | 26 |
| Gap distance | L |
| First distance | l₁ |
| Second distance | l₂ |
| Third distance | l₃ |
| Radio frequency module | 25 |
| Processor | 31 |
| Memory | 32 |
| Power supply module | 33 |
| Another input/output device | 34 |
| Housing | 40 |
| Middle frame | 41 |
| First middle frame | 411 |
| Second middle frame | 412 |
| Rear cover | 42 |
| First rear cover | 421 |
| Second rear cover | 422 |
| Internal structure | 50 |
| First battery cell | 511 |
| Second battery cell | 512 |
| First circuit board assembly | 521 |
| Second circuit board assembly | 522 |
| First gap | G1 |
| Second gap | G2 |
| First edge region | A |
| Second edge region | B |
| Third edge region | C |
| First plane | p1 |
| Second plane | p2 |

This application is further described with reference to the accompanying drawings in the following specific implementations.

### DESCRIPTION OF EMBODIMENTS

5 The following clearly describes the technical solutions in implementations of this application with reference to the accompanying drawings in implementations of this application. The accompanying drawings are for illustrative descriptions only, and are merely schematic drawings, and cannot be construed as limitation on this application. Apparently, the described implementations are only a part of rather than all of implementations of this application. All other implementations obtained by a person of ordinary skill in the art based on implementations of this application without creative efforts shall fall within the protection scope of this application.

Unless otherwise defined, meanings of all technical and scientific terms used in this application are the same as meanings usually understood by a person skilled in the art. In this application, terms used in this specification are merely intended to describe the specific implementations, but are not intended to limit this application.

This application provides an antenna system and an electronic device. The antenna system of an electronic device may include one near field communication (near field communication, NFC) antenna and N conventional antennas. A gap distance L exists between the NFC antenna and each of M conventional antennas, and the gap distance is a closest spatial distance between each conventional antenna and the NFC antenna. The gap distance of each antenna in the N conventional antennas other than the M conventional antennas is greater than L. Each of the M conventional antennas is grounded through a blocking device, and the blocking device is one of devices such as a capacitor, a band-pass, a band-stop, and a high-pass filter. The blocking device is configured to block a radio frequency signal that is in an NFC antenna frequency band and that is generated in the M conventional antennas. The M conventional antennas correspond to M gap distances (L includes l₁, l₂, l₃. . . . l_{M}). N and M are positive integers, and N is greater than or equal to M. In an implementation of this application, during assembling of the antenna system in the electronic device, because space is limited, and an assembled device is complex, interference between the NFC antenna and the conventional antenna exists, and assembling space of the electronic device is wasted. In an implementation of this application, because the gap distance L exists between the NFC antenna and the conventional antenna, a size range of the gap distance L is 0.001 mm to 20 mm, and at least one antenna in the conventional antennas is grounded through the blocking device. Because a frequency range difference between the NFC antenna and the conventional antenna is relatively large, for the conventional antenna with a high-frequency radio frequency range, the blocking device can isolate or block a signal in a radio frequency range of the NFC antenna, so that signal communication in only an operating frequency band of the conventional antenna is ensured. In this way, a radiation effect of the NFC antenna and the conventional antenna can be improved, and interference can be reduced.

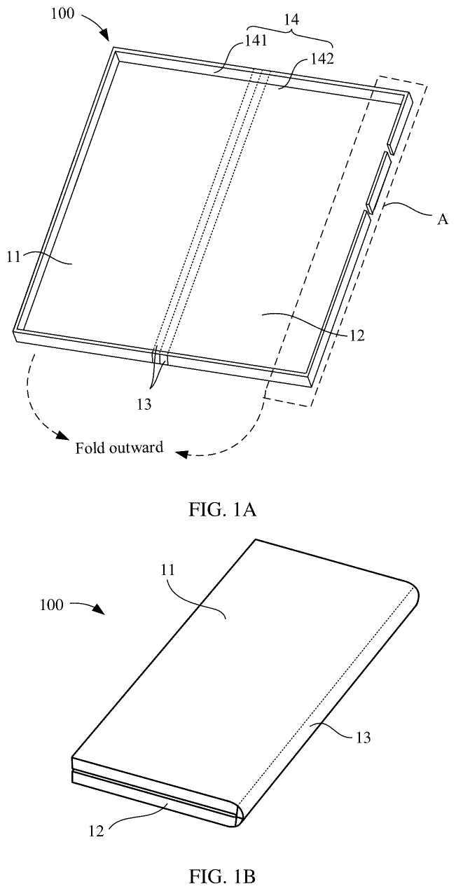

FIG. 1A and FIG. 1B are schematic diagrams of a structure of a foldable electronic device 100 according to an implementation of this application. The electronic device 100 includes but is not limited to an electronic apparatus such as a mobile phone, a tablet computer, or a wearable device.

As shown in FIG. 1A and FIG. 1B, the electronic device 100 includes a first body 11 and a second body 12 that are connected to each other. In an implementation of this application, the electronic device 100 further includes a connecting portion 13 disposed between the first body 11 and the second body 12. The first body 11 and the second body 12 are connected through the connecting portion 13, and the first body 11 and the second body 12 can be folded or unfolded relative to each other through the connecting portion 13, so that the electronic device 100 can have two use modes. FIG. 1A is a schematic diagram of a structure of the electronic device 100 in a use mode of an unfolded state. FIG. 1B is a schematic diagram of a structure of the electronic device 100 in a use mode of a folded state. The electronic device 100 in the unfolded state shown in FIG. 1A is folded outward to form the electronic device 100 in the folded state shown in FIG. 1B.

In an implementation of this application, a right side edge of the electronic device 100 in the unfolded state is a first edge region A. M conventional antennas and one NFC antenna are integrated in the first edge region A.

A connection structure (not shown in the figure), such as a rotating shaft or a hinge structure, may be further disposed on the connecting portion 13. The first body 11 and the second body 12 are connected through the connection structure, and the first body 11 and the second body 12 may rotate through the connection structure, so that the first body 11 and the second body 12 can switch between a folded relative to each other state and the unfolded relative to each other state.

In an implementation of this application, the electronic device 100 further includes a display 14 disposed on the first body 11 and the second body 12. The display 14 is configured to display a visual output to a user, and the visual output may include a graph, a text, an icon, a video, and the like. The display 14 may include a first display 141 and a second display 142. The first display 141 may be disposed on the first body 11, and the second display 142 may be disposed on the second body 12. The first display 141 and the second display 142 are coupled to each other, so that the display 14 can be continuously disposed on a same side of the first body 11 and the second body 12. When being in the folded state, the electronic device 100 has a display of a small area, so that a use requirement of a user for portability can be met. The display 14 may be a flexible screen. When the electronic device 100 is in the folded state, the display 14 may be hidden in an inner side of the electronic device 100, or may be exposed to an outer side of the electronic device 100. A type of the display 14 and a presentation manner of the display 14 of the electronic device 100 in the folded state are not limited in this application. In FIG. 1B, an example in which the display 14 is exposed to the outer side of the electronic device 100 when the electronic device 100 in the folded state is used for illustration.

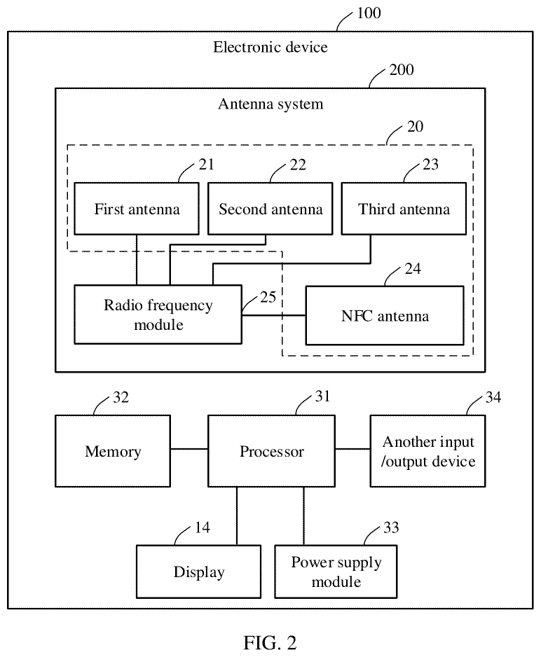

FIG. 2 is a schematic diagram of a structure of a functional module of an electronic device 100. As shown in FIG. 2, in addition to a display 14, the electronic device 100 may further include a processor 31, a memory 32, a power supply module 33, and another input/output device 34.

The processor 31 is used as a logic operation and control center of the electronic device 100, and is mainly responsible for functions such as data collection, data conversion, data processing, logic operation, communication, and drive output execution. The processor 31 may include a plurality of input/output ports, and the processor 31 may communicate and exchange information with another functional module or external device through the plurality of input/output ports, so that functions such as driving and control of the electronic device 100 can be implemented.

The memory 32 may be accessed by the processor 31, a peripheral interface (not shown in the figure), or the like, to implement data storage, invoking, or the like. The memory 32 may include a high-speed random access memory, and may further include a non-volatile memory, such as one or more disk storage devices, a flash memory device, or another volatile solid-state storage device.

The power supply module 33 is configured to supply power to another functional module of the electronic device 100 and perform power supply management, so that the another functional module of the electronic device 100 can operate normally.

The another input/output device 34 may include a device configured to implement a function supported by the electronic device 100, such as a speaker, a touch pad, a camera, a function key, or an I/O port, to implement interaction between the electronic device 100 and a user.

In this implementation, the electronic device 100 further has a wireless communication function. Correspondingly, the electronic device 100 further includes an antenna system 200. The antenna system 200 includes at least an antenna 20 and a radio frequency module 25. The antenna 20 may be coupled to the radio frequency module 25 through a transmission element (not shown in the figure), such as a coaxial cable or a microstrip, to implement wireless signal transmission, so that communication between the electronic device 100 and another network device is established. In the electronic device 100, to meet a use requirement of the user for using various wireless communication technologies, the antenna 20 usually includes a plurality of antenna elements. Each antenna element may be configured to cover one or more communication frequency bands. Different antenna elements may also be multiplexed to increase antenna utilization. The plurality of antenna elements may be distributed on the first body 11 and/or the second body 12, and there are various types of antennas, such as, a monopole (monopole) antenna, a dipole (dipole) antenna, an inverted F-shaped antenna (inverted F-shaped antenna, IFA), or a left-handed antenna. For example, the antenna 20 may include a conventional antenna and an NFC antenna 24, and the conventional antenna may include a first antenna 21, a second antenna 22, and a third antenna 23. The antenna 20 may further include another antenna. This is not limited in this application.

Near field communication is gradually evolved from integration of radio frequency identification (radio frequency identification, RFID) and interconnection and interworking technologies. An application frequency band of the near field communication is 13.56 MHz (namely, an operating frequency band of the NFC antenna), a data rate is 106 kbit/s to 848 kbit/s, and a communication distance is usually 5 cm or less. This technology plays an important role in fields such as access control, public transportation, and mobile phone payment. The NFC antenna 24 may include a radiator of the NFC antenna, to generate NFC performance. Two terminals of the radiator of the NFC antenna are respectively connected to a feeding network and a metal ground. For example, the first terminal of the radiator of the NFC antenna may be a feeding terminal, and the second terminal may be a grounding point. A current provided by the feeding network flows into the feeding terminal, and a current from the feeding terminal to the grounding point is generated, so that a magnetic field is generated. In a process of assembling of the NFC antenna, a coil needs to be wound around the antenna radiator, to generate the magnetic field.

The conventional antenna may be a low frequency band antenna (600 MHz to 960 MHz), such as, an LTE B28 (703 MHz to 803 MHz) or an LTE B8 (880 MHz to 960 MHz). The conventional antenna may alternatively be a high frequency band antenna, such as N79 (4.4 GHz to 5 GHz), or certainly may be of a higher frequency band. This is not limited in this application. In this embodiment of this application, a frequency of the conventional antenna needs to be above 500 MHz.

It may be understood that the electronic device 100 may further include a circuit board assembly (not shown in the figure) disposed in the first body 11 and/or the second body 12. The circuit board assembly is configured for electronic components, such as, the radio frequency module 25, the processor 31, and the memory 32, included in the electronic device 100 to be disposed on. The circuit board assembly may be a flexible circuit board assembly or a rigid-flexible circuit board assembly.

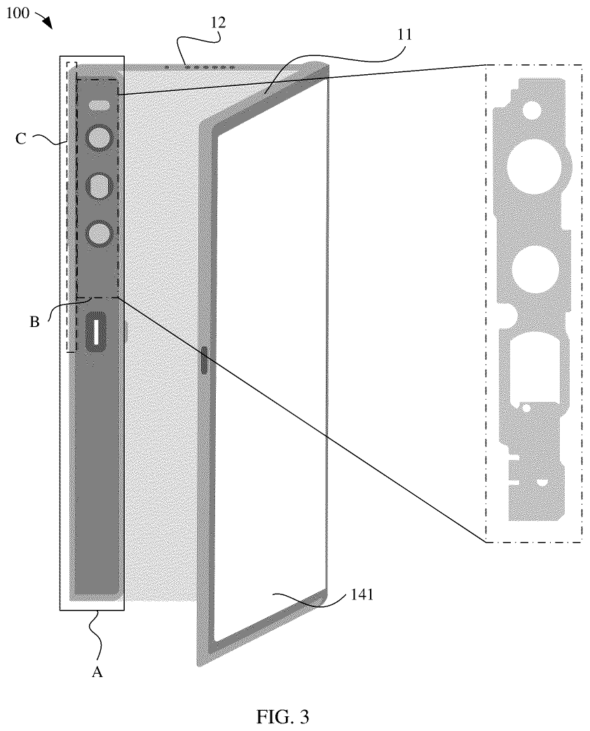

FIG. 3 is another schematic diagram of a structure of a foldable electronic device 100 according to an implementation of this application.

As shown in FIG. 3, the electronic device 100 is in a semi-folded state (or a semi-unfolded state), and an acute angle is formed between the first body 11 and the second body 12. In FIG. 3, a first display 141 can be displayed from a side surface, and a rear cover of a first edge region A can be completely displayed. In a possible implementation, the first edge region A may also be referred to as a hilt region, and a thickness of the first edge region A is obviously thicker than a thickness of another region. A plurality of antennas may be assembled in the first edge region A of the electronic device 100. For example, the first edge region A may include an antenna 20 (namely, the first antenna 21, the second antenna 22, the third antenna 23, and the NFC antenna 24 in FIG. 2). A spatial region in which the NFC antenna 24 is located is a second edge region B.

A spatial region in which conventional antennas (for example, the first antenna 21, the second antenna 22, and the third antenna 23) assembled near the NFC antenna 24 in the antenna 20 are located is a third edge region C. It may be understood that, in a spatial region, the first edge region A includes the second edge region B and the third edge region C.

As shown in a right side of FIG. 3, for example, because the NFC antenna needs to be assembled with a component such as a camera, a middle of the NFC antenna in the second edge region B is hollowed out based on an actual situation. For a current terminal product, to improve a battery life of an electronic device, a battery capacity is continuously increased, and consequently an area of a main board region is gradually decreased. In addition, a camera shape and region take up space. As a consequence, a region left for an NFC radiator is smaller, and an area of the NFC antenna (radiator) can reach approximately 700 mm². It should be noted that, for a total area of the NFC antenna radiator shown in the right side of FIG. 3, the area of the antenna should include an area of the hollowed-out part.

In an assembling solution, because the first edge region A of the electronic device 100 is excessively narrow, the NFC antenna is also excessively narrow. As a consequence, a specific radiation blind region of the NFC antenna exists, and card swiping may fail when a user swipes a card by using NFC. Consequently, the area of the NFC antenna is small, and radiation performance is poor.

In addition, in an assembling solution, an NFC antenna radiator made of a nanocrystalline material is assembled on a lower surface of the hilt region. Because performance of nanocrystals is approximately 20% worse than that of ferrites, a magnetic loss is large. To compensate for a loss caused by use of the nanocrystals, a coil area of the NFC antenna needs to be increased, and the coil extends to a battery region. As a consequence, a thickness of the entire electronic device 100 is increased by approximately 0.2 mm. This is unfavorable to a tendency and target of lightness and thinness of an electronic product. Further, assembling of the NFC antenna extends to the battery region. When the electronic device 100 is in a folded state, a radiation region of the NFC antenna involves the battery region and the main board region. As a consequence, radiation performance of the NFC antenna becomes poor. In addition, the antenna radiator of the NFC antenna is relatively close to an antenna radiator of the conventional antenna. As a consequence, in a radiation process of the NFC antenna, suspended metal around the NFC antenna generates a clutter, increasing radiation power consumption of the NFC antenna. In addition, grounding of the conventional antenna also causes radiation energy of the NFC antenna to be leaked to a ground through grounding of the conventional antenna. As a result, a radiation effect of the NFC antenna is relatively poor.

For the foregoing problems, an embodiment of this application provides an antenna system. The antenna system includes one NFC antenna and N conventional antennas. Each of the N conventional antennas includes a feed point, a grounding point, and a radiating branch. M conventional antennas in the N conventional antennas include blocking devices. An i^{th} antenna includes an i^{th} radiating branch, an i^{th} feed point, an i^{th} blocking device, and an i^{th} grounding point. The i^{th} radiating branch is coupled to the i^{th} feed point, and the i^{th} radiating branch is coupled to the i^{th} grounding point through the i^{th} blocking device. Each of the M conventional antennas is grounded through the blocking device, and the blocking device is one of blocking devices such as a capacitor, a band-pass circuit, a band-stop circuit, and a high-pass filter. The blocking device is configured to block a radio frequency signal that is in an NFC antenna frequency band and that is generated in the M conventional antennas. In this embodiment of this application, the M conventional antennas can receive the radio frequency signal in the operating frequency band of the NFC antenna, and the blocking device can prevent the radio frequency signal in the operating frequency band of the NFC antenna from leaking to a ground, so that reduction in signal radiation strength is avoided. In addition, a gap distance L exists between the NFC antenna and the M conventional antennas, L is a shortest spatial distance between antenna radiators of the M conventional antennas and a radiator of the NFC antenna, and a gap distance between the i^{th} antenna and the NFC antenna is an i^{th} distance lᵢ (for example, L includes l₁, l₂, l₃. . . . l_{M}). N and M are positive integers, and N is greater than or equal to M. In an implementation of this application, during assembling of the antenna system in an electronic device, space is limited, and an assembled device is complex. As a result, interference to the NFC antenna exists, and assembling space of the electronic device is wasted. The gap distance L exists between the NFC antenna and each of the M conventional antennas. Because a frequency range difference between the NFC antenna and the conventional antenna is relatively large, for the conventional antenna with a high-frequency radio frequency range, the blocking device can isolate or filter a signal in a radio frequency range of the NFC antenna, so that signal communication in only an operating frequency band of the conventional antenna is ensured. In this way, a grounding terminal of the conventional antenna can prevent ground leakage of radiation energy of the NFC antenna, so that a radiation effect of the NFC antenna can be improved, and interference between antennas is reduced. In addition, because a received radiation signal in the operating frequency band of the NFC antenna in the conventional antenna does not leak to the ground, the conventional antenna in another frequency band performs secondary radiation on an NFC frequency band signal. This is equivalent to increasing a lateral width of an NFC antenna radiator, and to increasing an area of the NFC antenna. In this way, a radiation blind region of the NFC antenna is reduced, and an NFC card swiping success rate is increased.

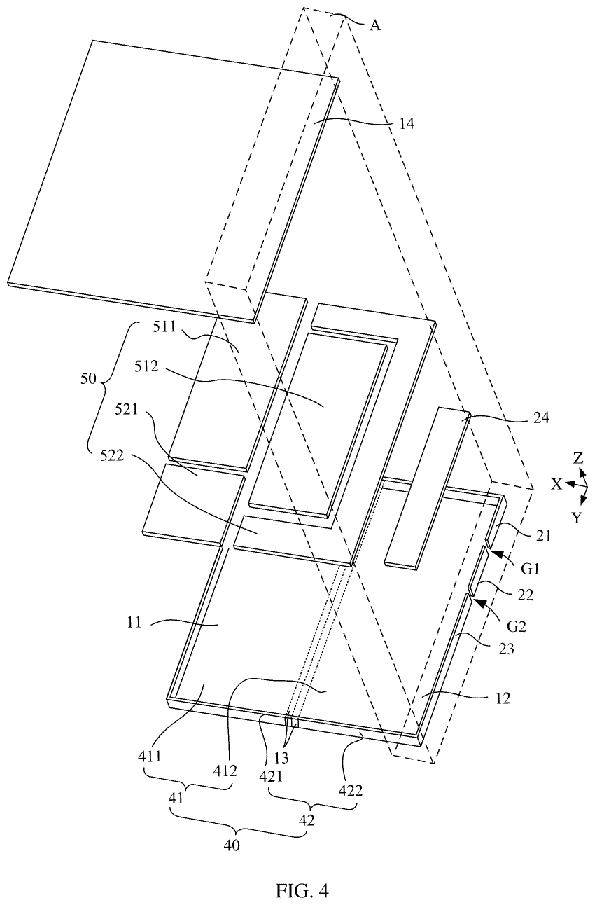

FIG. 4 is a schematic exploded diagram of a structure of an electronic device 100. As shown in FIG. 4, the electronic device 100 includes at least a display 14, a housing 40, and an internal structure 50 and an NFC antenna 24 that are accommodated in an accommodating cavity enclosed by the display 14 and the housing 40. In FIG. 4, the electronic device 100 is in an unfolded state, and a lateral direction of a screen is an X-axis, a longitudinal direction of the screen is a Y-axis, and a direction perpendicular to the screen is a Z-axis, so that an XYZ spatial coordinate system is established. An assembly structure of the electronic device 100 is described in the XYZ spatial coordinate system.

Specifically, the housing 40 includes a middle frame 41 and a rear cover 42, and the middle frame 41 is connected to at least an edge region of the rear cover 42. The middle frame 41 includes a first middle frame 411 corresponding to a first body 11 and a second middle frame 412 corresponding to a second body 12. The rear cover 42 includes a first rear cover 421 corresponding to the first body 11 and a second rear cover 422 corresponding to the second body 12. A whole formed by the first middle frame 411 and the first rear cover 421 may be connected, through a connecting portion 13, to a whole formed by the second middle frame 412 and the second rear cover 422.

Refer to FIG. 4. In an implementation of this application, the internal structure 50 includes but is not limited to a first battery cell 511 and a first circuit board assembly 521 that are corresponding to the first body 11, and a second battery cell 512 and a second circuit board assembly 522 that are corresponding to the second body 12. The first circuit board assembly 521 is configured for an electronic component included in the first body 11 to be disposed on. The second circuit board assembly 522 is configured for an electronic component included in the second body 12 to be disposed on. The first battery cell 511 and the second battery cell 512 are configured to supply power to the electronic component disposed on the first body 11 and/or the second body 12. In another implementation, the electronic device 100 may alternatively include one battery cell or more than two battery cells.

It may be understood that the electronic device 100 shown in FIG. 4 is merely an example of the electronic device, and the electronic device 100 may have more or fewer components than that shown in FIG. 4, may have a combination of two or more components, or may have a different component configuration.

Refer to FIG. 4. In an implementation of this application, an antenna system 200 includes at least a first antenna 21, a second antenna 22, a third antenna 23, and the NFC antenna 24. The first antenna 21, the second antenna 22, and the third antenna 23 are M conventional antennas above 500 MHz. The first antenna 21, the second antenna 22, and the third antenna 23 are disposed in a first edge region A of the first body 11. In this implementation, the first antenna 21, the second antenna 22, and the third antenna 23 are all disposed on the first middle frame 411 in the first edge region A in the first body 11, and the first antenna 21 and the second antenna 22 are separated by a first gap G1. The second antenna 22 and the third antenna 23 are separated by a second gap G2.

Specifically, the first antenna 21 includes a first radiating branch 211 (not shown in the figure). The second antenna 22 includes a second radiating branch 221 (not shown in the figure). The third antenna 23 includes a third radiating branch 231 (not shown in the figure). The first radiating branch 211 and the second radiating branch 221 are separated by the first gap G1. The second radiating branch 221 and the third radiating branch 231 are separated by the second gap G2.

In this embodiment of this application, the first antenna 21, the second antenna 22, and the third antenna 23 may be assembled at positions adjacent to the NFC antenna 24. The first antenna 21, the second antenna 22, and the third antenna 23 may be the M conventional antennas. The conventional antenna is around the NFC antenna 24, but cannot be closely attached to the NFC antenna 24 (that is, a gap exists between the conventional antenna and the NFC antenna 24). In this case, N is an integer greater than or equal to 3.

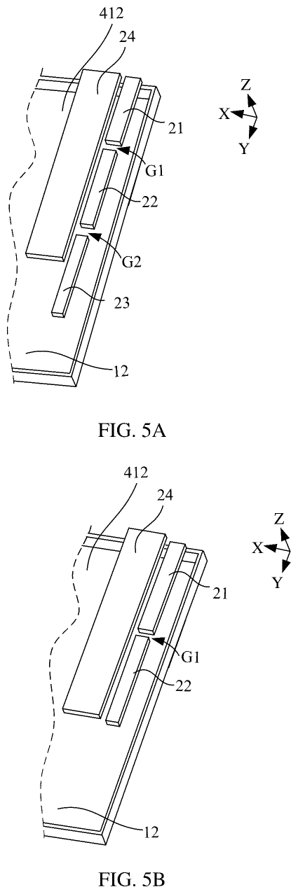

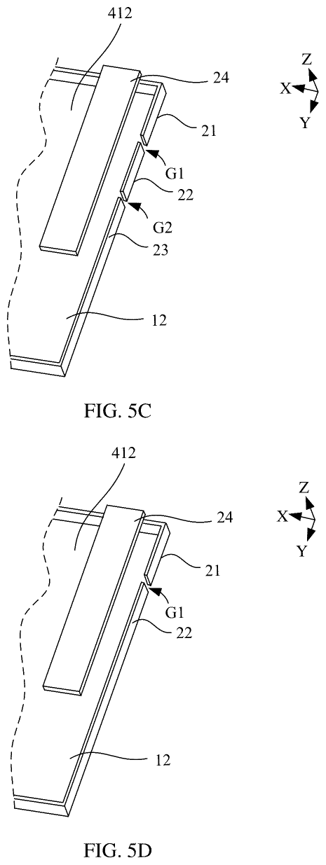

To understand position relationships between the conventional antenna and the NFC antenna 24 more clearly, an embodiment of this application provides FIG. 5A to FIG. 5D based on FIG. 4. FIG. 5A to FIG. 5D are schematic exploded programs of antenna position relationships of an electronic device 100 according to an embodiment of this application. The following describes position relationships between the first antenna 21 and the second antenna 22 (the third antenna 23 may be included) and the NFC antenna 24 in the electronic device 100 with reference to FIG. 5A to FIG. 5D. The position relationship between the conventional antenna and the NFC antenna 24 may be described by using the XYZ spatial coordinate system as a reference system. In FIG. 5A to FIG. 5D, each of the M conventional antennas in the N conventional antennas in the electronic device 100 is assembled at a position relatively close to the NFC antenna. The following describes only position relationships between the M conventional antennas and the NFC antenna.

In a possible implementation, as shown in FIG. 5A and FIG. 5B, radiators of the M conventional antennas and a radiator of the NFC antenna 24 are placed in parallel.

In FIG. 5A, a quantity M of the conventional antennas is 3, namely, the first antenna 21, the second antenna 22, and the third antenna 23. The radiator of the NFC antenna 24 may be in a sheet shape. Radiators of the first antenna 21, the second antenna 22, and the third antenna 23 are on a same plane, and the plane on which the radiators of the first antenna 21, the second antenna 22, and the third antenna 23 are located is parallel to a plane on which the NFC antenna 24 is located. The two planes may be a same plane, or may be different planes. The radiator of the first antenna 21 and the radiator of the second antenna 22 are separated by the first gap G1. The radiator of the second antenna 22 and the radiator of the third antenna 23 are separated by the second gap G2.

In FIG. 5B, a quantity M of the conventional antennas is 2, namely, the first antenna 21 and the second antenna 22. The radiator of the NFC antenna 24 may also be in a sheet shape. The radiators of the first antenna 21 and the second antenna 22 are on a same plane, and the plane on which the radiators of the first antenna 21 and the second antenna 22 are located is parallel to a plane on which the NFC antenna 24 is located. The two planes may be a same plane, or may be different planes. The radiator of the first antenna 21 and the radiator of the second antenna 22 are separated by the first gap G1.

In implementations shown in FIG. 5A and FIG. 5B, that a rear cover of the electronic device 100 is at the bottom is used as a reference, and the radiators of the M conventional antennas are located obliquely below (in the X-axis and Z-axis directions) the radiator of the NFC antenna 24. Optionally, based on the foregoing reference, the radiators of the M conventional antennas may alternatively be located obliquely above the radiator of the NFC antenna 24. Details are not described herein again. Optionally, based on the foregoing reference, the radiators of the M conventional antennas may alternatively be on a same plane as the radiator of the NFC antenna 24. Details are not described herein again.

In another possible implementation, as shown in FIG. 5C and FIG. 5D, the radiators of the M conventional antennas are perpendicular to the radiator of the NFC antenna 24.

In FIG. 5C, a quantity M of the conventional antennas is 3, namely, the first antenna 21, the second antenna 22, and the third antenna 23. In this case, the first antenna 21, the second antenna 22, and the third antenna 23 may be included in a region of the second middle frame 412 in the first edge region A. The NFC antenna 24 (radiator) may be in a sheet shape. The first antenna 21, the second antenna 22, and the third antenna 23 (radiators) are on a same plane. The plane on which the first antenna 21, the second antenna 22, and the third antenna 23 (radiators) are located is perpendicular to a plane on which the NFC antenna 24 (radiator) is located. The radiator of the first antenna 21 and the radiator of the second antenna 22 are separated by the first gap G1. The radiator of the second antenna 22 and the radiator of the third antenna 23 are separated by the second gap G2.

In FIG. 5D, a quantity M of the conventional antennas is 2, namely, the first antenna 21 and the second antenna 22. In this case, the first antenna 21 and the second antenna 22 may be included in the region of the second middle frame 412 in the first edge region A. The NFC antenna 24 (radiator) may be in a sheet shape. The first antenna 21 and the second antenna 22 (radiators) are on a same plane. The plane on which the radiator of the first antenna 21 and the radiator of the second antenna 22 are located is perpendicular to a plane on which the NFC antenna 24 is located. The radiator of the first antenna 21 and the radiator of the second antenna 22 are separated by the first gap G1.

Optionally, the second middle frame 412 may be partially or entirely made of a non-conductive material (such as, glass or plastic), and the first radiating branch 211 (namely, the first antenna 21) and the second radiating branch 221 (namely, the second antenna 22) (and optionally, the third radiating branch 231) are attached to an inner side of the first middle frame 411. Assembling between the radiators of the M conventional antennas and the radiator of the NFC antenna 24 may be not limited. Optionally, the second rear cover 422 may be made of a metal material, and the first radiating branch 211 and the second radiating branch 221 form a partial structure of the second rear cover 422. For example, the first radiating branch 211 (namely, the first antenna 21) and the second radiating branch 221 (namely, the second antenna 22) (and optionally, the third radiating branch 231) may be cut-off metal accessories obtained by providing a gap on the second rear cover 422. Optionally, the second rear cover 422 may be made of a non-conductive material (such as, glass or plastic), and the first radiating branch 211 (namely, the first antenna 21) and the second radiating branch 221 (namely, the second antenna 22) (and optionally, the third radiating branch 231) are attached to an inner side of the second rear cover 422.

It should be noted that a quantity M of the foregoing conventional antennas of the NFC antenna may be 2, or 3, or 1, 4, 5, 6, 7, or the like. The quantity M of the conventional antennas is not limited in this application. In addition, the M conventional antennas include the first antenna 21 and the second antenna 22 (and optionally, the third antenna 23). In addition, a specific shape of the antenna 20 is related to an internal design of the electronic device 100, and may be flexibly changed based on a requirement. Specific shapes of the radiators of the first antenna 21, the second antenna 22, the third antenna 23, and the NFC antenna 24 are not limited in this application, and the radiator of the antenna may be in a sheet shape or another shape.

In still another possible implementation, the M conventional antennas (radiators) are neither parallel nor perpendicular to the NFC antenna (radiator). In other words, a specific angle exists between a plane on which the M conventional antennas (radiators) are located and a plane on which the NFC antenna (radiator) is located. The specific angle presented needs to be determined based on an assembling position inside the electronic device. This is not limited in this application. Optionally, the M conventional antennas (radiators) may alternatively not be on a same plane. This is not limited in this application.

Each of the conventional antennas includes a radiating branch, a feed point, and a grounding point. The radiating branch of each antenna needs to be separately coupled to the feed point and the grounding point. Certainly, the NFC antenna 24 also includes a fourth radiating branch, a fourth feed point, and a fourth grounding point, and the fourth radiating branch also needs to be separately coupled to the fourth feed point and the fourth grounding point. In an implementation of this application, a specific distance needs to be maintained (a gap exists) between the NFC antenna 24 (radiator) and each of the M conventional antennas. In addition, each of the M conventional antennas may be connected to the grounding point through the blocking device. The blocking device may include one or more of devices such as a capacitor, a band-pass, a band-stop, and a high-pass filter.

A specific distance exists between the NFC antenna 24 (radiator) and each of the M conventional antennas. In this embodiment of this application, a nearest spatial distance between the conventional antenna and the NFC antenna (radiator) is a gap distance. For example, in FIG. 5A, a gap distance between the first antenna 21 and the NFC antenna 24 is a first distance 11: a gap distance between the second antenna 22 and the NFC antenna 24 is a second distance 12: and a gap distance L between the third antenna 23 and the NFC antenna 24 is a third distance 13. The gap distances of the conventional antennas may be equal, or may be unequal. This is not limited in this application.

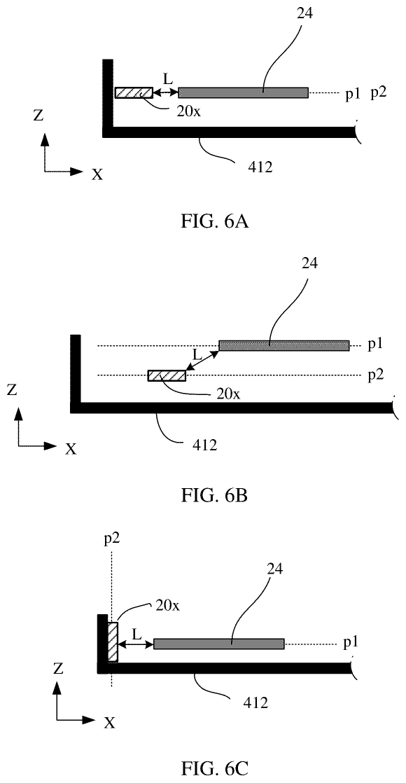

FIG. 6A to FIG. 6C are schematic diagrams of a group of position relationships between a conventional antenna 20x and an NFC antenna 24 (radiator) according to an embodiment of this application. To accurately represent the position relationships between the two types of antennas, the conventional antenna 20x, the NFC antenna 24, and the second middle frame 412 may be partially projected onto an XOZ plane.

With reference to the position relationship shown in FIG. 5A or FIG. 5B, when a plane on which the conventional antenna 20x (radiator) is located is parallel to a plane on which the NFC antenna 24 (radiator) is located, to further clearly determine the position relationship between the conventional antenna 20x and the NFC antenna 24, in the position relationships in FIG. 6A and FIG. 6B, the conventional antenna 20x, the NFC antenna 24, and the second middle frame 412 may be partially projected onto a plane, namely, the XOZ plane, perpendicular to the conventional antenna 20x, the NFC antenna 24, and the second middle frame 412. The NFC antenna 24 is on a first plane p1, and the conventional antenna 20x is on a second plane p2. In addition, the NFC antenna is parallel to the conventional antenna 20x. As shown in FIG. 6A, the NFC antenna 24 and the conventional antenna 20x are on a same plane, and the first plane pl and the second plane p2 are a same plane. In FIG. 6B, the first plane pl is parallel to the second plane p2, and the first plane is above the second plane. The NFC antenna 24 is on an upper right side of the conventional antenna 20x. In this case, the conventional antenna 20x and the NFC antenna 24 are placed in parallel. In FIG. 6A and FIG. 6B, the conventional antenna 20x is flush with the NFC antenna 24. In other words, the NFC antenna 24 and the conventional antenna 20x basically do not overlap each other when viewing is performed (on the projections onto the XOY plane) from top to bottom. In other words, a position of the conventional antenna 20x and a position of the NFC antenna 24 are basically staggered. In the position relationship in FIG. 6A, it may be determined that a gap distance L is a spatial distance between a leftmost side of the NFC antenna 24 and a rightmost side of the conventional antenna 20x. In the position relationship in FIG. 6B, it may be determined that a gap distance L is a spatial distance between a lower left corner of the NFC antenna 24 and an upper right corner of the conventional antenna 20x.

With reference to the position relationship shown in FIG. 5C or FIG. 5D, when a plane on which the conventional antenna 20x (radiator) is located is perpendicular to a plane on which the NFC antenna 24 (radiator) is located, to further clearly determine the position relationship between the conventional antenna 20x and the NFC antenna 24, in a position relationship in FIG. 6C, the conventional antenna 20x, the NFC antenna 24, and the second middle frame 412 may be partially projected onto a plane, namely, the XOZ plane, perpendicular to the conventional antenna 20x, the NFC antenna 24, and the second middle frame 412. As shown in FIG. 6C, it is assumed that the NFC antenna 24 is on the first plane p1, and conventional antennas 20x (a plurality of antennas) are on a same plane, namely, the second plane p2. The first plane pl is perpendicular to the second plane p2. In other words, the conventional antenna 20x is perpendicular to the NFC antenna 24. That the second middle frame 412 is in lower left sides of the first plane pl and the second plane p2 is used as a reference. The conventional antenna 20x is on a left side of the NFC antenna 24, and it may be determined that a gap distance L is a distance that is between a rightmost side of the conventional antenna 20x and a leftmost side of the NFC antenna 24 and that is on a projection line of the conventional antenna onto the first plane p1.

It should be noted that, in FIG. 6C, a projection of the left part of the second middle frame 412 and a projection of the conventional antenna 20x onto the XOZ plane may overlap, or may not overlap. In this application, to clearly represent the conventional antenna 20x, the second middle frame 412 is separately shown.

Optionally, in addition to the position relationships shown in FIG. 6A and FIG. 6C, the conventional antenna 20x and the NFC antenna 24 may alternatively be in another position relationship. For example, the conventional antenna 20x is neither parallel nor perpendicular to the NFC antenna 24 (radiator). This is not limited in this application.

It should be noted that, in FIG. 6A to FIG. 6C, a plurality of antennas in the conventional antenna 20x may be specifically measured. Herein, it may be idealized that the first distance and the second distance (and optionally, the third distance) are equal. During actual processing, differentiation processing may be performed based on a requirement. Details are not described herein.

In this embodiment of this application, a range of the gap distance L is 0.2 mm to 10 mm. For example, the range of L is 0.5 mm to 9 mm, 0.5 mm, 0.7 mm, 1 mm, 1.7 mm, 1 mm to 10 mm, 3.2 mm, 5.2 mm, 7.2 mm, 8.2 mm, 9 mm and 10 mm, or the like. This is not specifically limited in this application. When the gap distance L between the NFC antenna and the M conventional antennas falls within the foregoing range, radiation performance of the NFC antenna can be significantly improved.

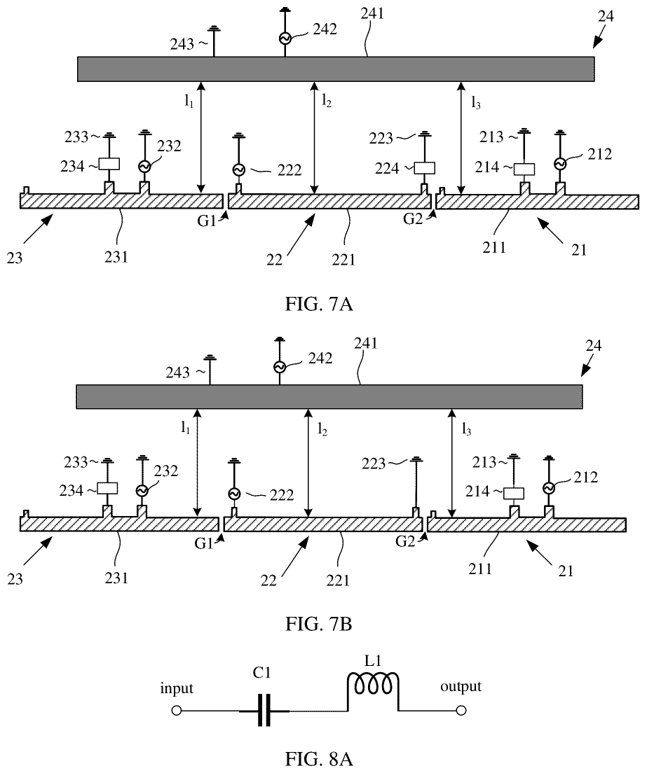

An antenna connection structure in which each of the M conventional antennas of the electronic device 100 is grounded through the blocking device is specifically described in FIG. 7A and FIG. 7B.

FIG. 7A and FIG. 7B are schematic diagrams of a group of connection structures of a conventional antenna and an NFC antenna according to an embodiment of this application.

Refer to FIG. 7A. In a first implementation, M conventional antennas include a first antenna 21, a second antenna 22, and a third antenna 23 (M is 3). The first antenna 21 includes a first radiating branch 211, a first feed point 212, a first grounding point 213, and a first blocking device 214. The second antenna 22 includes a second radiating branch 221, a second feed point 222, a second grounding point 223, and a second blocking device 224. The third antenna 23 includes a third radiating branch 231, a third feed point 232, a third grounding point 233, and a third blocking device 234. The first radiating branch 211 and the second radiating branch 221 are separated by a first gap G1. The second radiating branch 221 and the third radiating branch 231 are separated by a second gap G2. The first radiating branch 211 is coupled to the first grounding point 213 through the first blocking device 214, and the first radiating branch 211 is further coupled to the first feed point 212. The second radiating branch 221 is coupled to the second grounding point 223 through the second blocking device 224, and the second radiating branch 221 is further coupled to the second feed point 222. The third radiating branch 231 is coupled to the third grounding point 233 through the third blocking device 234, and the third radiating branch 231 is further coupled to the third feed point 232. In addition, the NFC antenna 24 includes a fourth radiating branch 241, a fourth feed point 242, and a fourth grounding point 243. The fourth radiating branch 241 is coupled to the fourth feed point 242 and the fourth grounding point 243.

In an implementation, the first feed point 212 may be coupled to a first radio frequency module (not shown in the figure) included in a radio frequency module 25 through a connecting member (not shown in the figure). For example, the connecting member may include an elastic component and a microstrip on a second circuit board assembly 522, and the elastic component is coupled to the first radio frequency module through the microstrip. The first radiating branch 211 is grounded through the first blocking device 214 and the first grounding point 213, and is coupled to the first radio frequency module through the first feed point 212. The first radiating branch 211 receives, through the first feed point 212, an internal electromagnetic wave signal input by the first radio frequency module, and radiates the internal electromagnetic wave signal to the outside. The first radiating branch 211 is further configured to receive an external electromagnetic wave signal, and transmit the external electromagnetic wave signal to the first radio frequency module through the first feed point 212. Then, a processor 31 performs corresponding signal processing on the external electromagnetic wave signal. In this way, wireless communication between the electronic device 100 and an external device can be implemented through the first antenna 21.

Similarly, the second feed point 222 may be coupled to a second radio frequency module (not shown in the figure) included in the radio frequency module 25 through a connecting member (not shown in the figure). The second radiating branch 221 is grounded through the second blocking device 224 and the second grounding point 223, and is coupled to the second radio frequency module through the second feed point 222. An operating principle of the second antenna 22 is the same as an operating principle of the first antenna 21. Details are not described herein again.

Similarly, the third feed point 232 may be coupled to a third radio frequency module (not shown in the figure) included in the radio frequency module 25 through a connecting member (not shown in the figure). The third radiating branch 231 is grounded through the third blocking device 234 and the third grounding point 233, and is coupled to the third radio frequency module through the third feed point 232. An operating principle of the third antenna 23 is also the same as the operating principle of the first antenna 21. Details are not described herein again.

Similarly, the fourth feed point 242 may be coupled to a fourth radio frequency module (not shown in the figure) included in the radio frequency module 25 through a connecting member (not shown in the figure). The fourth radiating branch 241 is directly grounded through the fourth grounding point 243, and is coupled to the fourth radio frequency module through the fourth feed point 242. An operating principle of the NFC antenna 24 is also the same as the operating principle of the first antenna 21. Details are not described herein again.

Refer to FIG. 7B. In a second implementation, M conventional antennas include a first antenna 21 and a third antenna 23 (M is 2, and N is 3). The first antenna 21 includes a first radiating branch 211, a first feed point 212, a first grounding point 213, and a first blocking device 214. The third antenna 23 includes a third radiating branch 231, a third feed point 232, a third grounding point 233, and a third blocking device 234. The first radiating branch 211 is coupled to the first grounding point 213 through the first blocking device 214, and the first radiating branch 211 is further coupled to the first feed point 212. The third radiating branch 231 is coupled to the third grounding point 233 through the third blocking device 234, and the third radiating branch 231 is further coupled to the third feed point 232. In addition, the NFC antenna 24 includes a fourth radiating branch 241, a fourth feed point 242, and a fourth grounding point 243. The fourth radiating branch 241 is coupled to the fourth feed point 242 and the fourth grounding point 243. The implementation shown in FIG. 7B is different from the implementation shown in FIG. 7A in that a second antenna 22 is directly connected to a second grounding point 223, and is grounded without a second blocking device. The second antenna 22 includes a second radiating branch 221, a second feed point 222, and the second grounding point 223 (excluding the second blocking device). The second radiating branch 221 is directly grounded through the second grounding point 223, and the second radiating branch 221 is further coupled to the second feed point 222.

In this embodiment of this application, a blocking device may include one or more of a capacitor, a band-pass, a band-stop, and a high-pass filter. Details are separately described below.

First, the blocking device is a capacitor. In other words, the first blocking device 214 is a first capacitor, the second blocking device 224 is a second capacitor, and the third blocking device 234 is a third capacitor. When the blocking device is a capacitor, a capacitance range of the capacitor may usually be 1 pF to 10 nF. For example, the capacitance is 1 pF, 100 pF, 1000 pF, 1 nF, 10 nF, or the like. Certainly, specific capacitance of the capacitor may alternatively be determined based on a radio frequency of a conventional antenna. For example, when an operating frequency band of the conventional antenna is above 2.4 GHz, a capacitance range of the capacitor is above 3 pF. When an operating frequency band of the conventional antenna is 1.7 GHz to 2.4 GHz, a capacitance range of the capacitor is above 10 pF. When an operating frequency band of the conventional antenna is 700 MHz to 900 MHz, a capacitance range of the capacitor is above 33 pF. However, for the NFC antenna, capacitance should be below a capacitance level of 10 nF, and anything else is not specifically limited in this application. Within the foregoing capacitance range, a radiation effect of the NFC antenna can be effectively improved.

The foregoing capacitor may be a direct current blocking capacitor, and the direct current blocking capacitor isolates two circuits. However, the direct current blocking capacitor has a function of transmitting a signal. As the capacitance for signal transmission increases, signal loss reduces, and large capacitance facilitates transmission of a low-frequency signal. A capacitor that is in a circuit and that is configured to isolate a direct current and to allow only an alternating current to pass through is referred to as a “direct current blocking capacitor” in the circuit.

Second, the blocking device is a band-pass circuit. A specific structure of the band-pass circuit is not limited in this application.

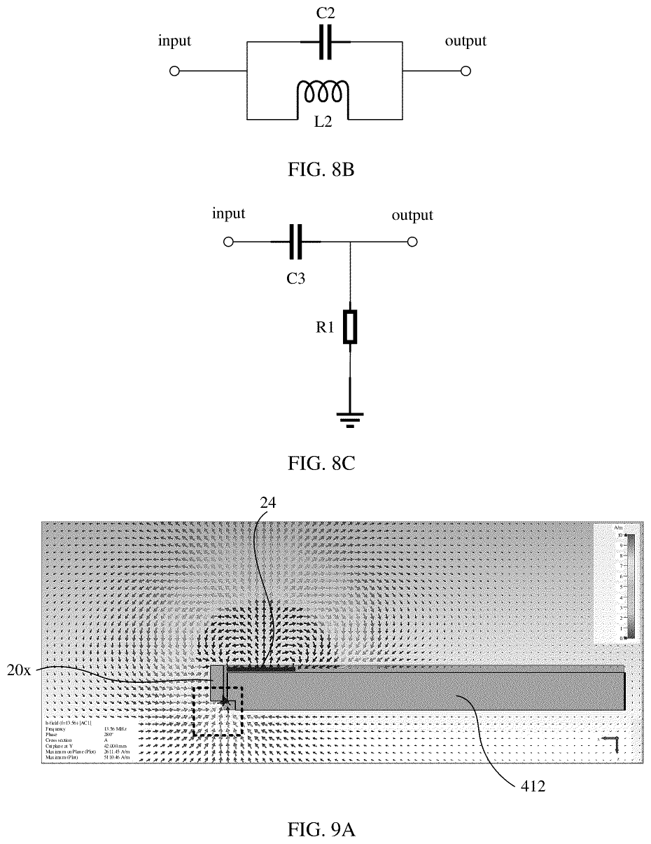

For example, FIG. 8A is a schematic diagram of a structure of a band-pass circuit. As shown in FIG. 8A, the band-pass circuit includes a capacitor C1 and an inductor L1, and the capacitor C1 and the inductor L1 are connected in series, so that the capacitor C1 and the inductor L1 may be equivalent to one large capacitor, and a radio frequency signal greater than a specific frequency (for example, 500 MHz) may be allowed to pass through.

Third, the blocking device is a band-stop circuit. A specific structure of the band-stop circuit is not limited in this application.

For example, FIG. 8B is a schematic diagram of a structure of a band-stop circuit. As shown in FIG. 8B, the band-stop circuit includes a capacitor C2 and an inductor L2, and the capacitor C2 and the inductor L2 are connected in parallel.

Fourth, the blocking device is a high-pass filter. A circuit structure of the high-pass filter may not be limited.

For example, FIG. 8C is a schematic diagram of a structure of a high-pass filter. As shown in FIG. 8C, the high-pass filter circuit may include a capacitor C3 and a resistor R1. A first end of the capacitor C3 is coupled to an input port, a second end of the capacitor C3 is coupled to an output port and a first end of the resistor, and a second end of the resistor RI is connected to a grounding point. The high-pass filter circuit can allow a signal with a frequency greater than a specific frequency to pass through. For example, a range of the high-pass filter may be above 500 MHz.

It should be noted that, in FIG. 8A to FIG. 8C, an input port is coupled to a radiating branch of each of M conventional antennas, and an output port is coupled to a grounding point of each of the M conventional antennas.

In embodiments of this application, the blocking device may include only a capacitor, only a band-pass circuit, only a band-stop circuit, or only a high-pass filter. Alternatively, the blocking device may include a capacitor and a band-pass circuit, a capacitor and a band-stop circuit, a band-pass circuit and a band-stop circuit, a capacitor and a high-pass filter, a band-pass circuit and a high-pass filter, or a band-stop circuit and a high-pass filter. Alternatively, the blocking device may include a capacitor, a band-pass circuit, and a band-stop circuit, include a band-pass circuit, a band-stop circuit, and a high-pass filter, include a capacitor, a band-stop circuit, and a high-pass filter, or include a capacitor, a band-pass circuit, and a high-pass filter. All manners of combination are not limited in this application. For example, in FIG. 7A, the first blocking device 214 is a capacitor, the second blocking device 224 is a high-pass filter, and the third blocking device 234 is a band-stop circuit. All cases are possible. This is not limited in this application.

In addition, a specific form of a terminal device is not limited in this application. The terminal device may be a foldable device, a non-foldable device, or a device such as a mobile phone, a tablet computer, or a smart band. This is not limited.

For electronic products, a product entity pursues a smaller size and lighter quality. Therefore, space for assembling internal components of an electronic device is very compact. Therefore, a solution in which a periphery of an NFC antenna is completely metal-free for performance improvement is undesirable. In an actual assembling process, antenna metal usually exists around the NFC antenna, and a position of the NFC antenna is close to a position of a conventional antenna. In this embodiment of this application, the blocking device is added, which is equivalent to disconnecting grounding that is in an NFC antenna frequency band and that is of the conventional antenna around the NFC antenna, to improve radiation performance of the NFC antenna, which is equivalent to improving performance by increasing clearance.

In conclusion, in this embodiment of this application, a key point of a relatively large difference between a frequency (13.56 Hz) of an NFC and a frequency of a conventional antenna is cleverly used, and a capacitor (blocking device), a band-pass circuit, a band-stop circuit, or a high-pass filter is added in a grounding circuit path of the conventional antenna (assumed to be 700 MHz), which is similar to adding a direct current blocking capacitor. In this way, the conventional antenna can prevent, by using a capacitor, a low-frequency alternating current radiation signal of 13.56 MHz from leaking to a ground, and allows a high-frequency alternating current signal above 700 MHz to pass through. This improves radiation performance of the NFC antenna.

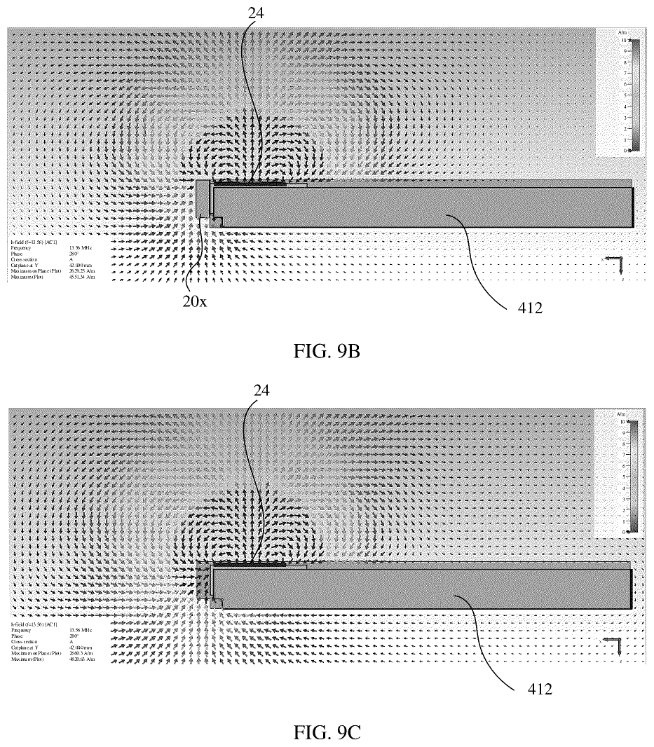

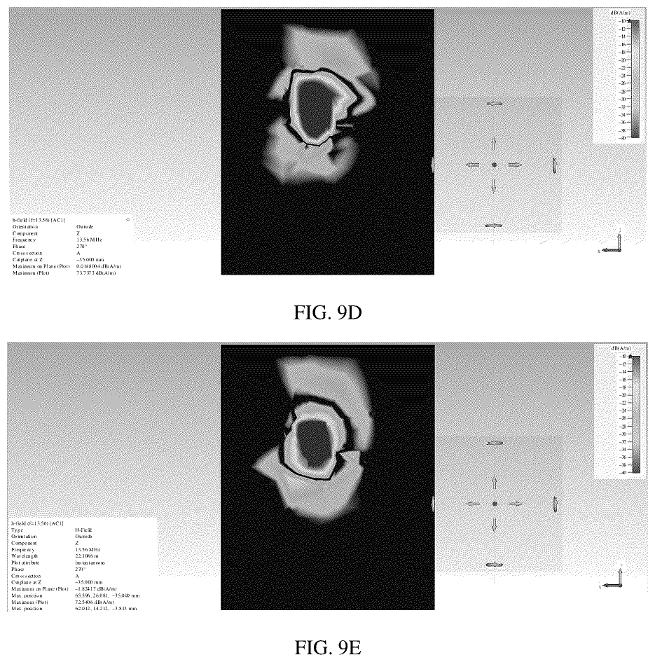

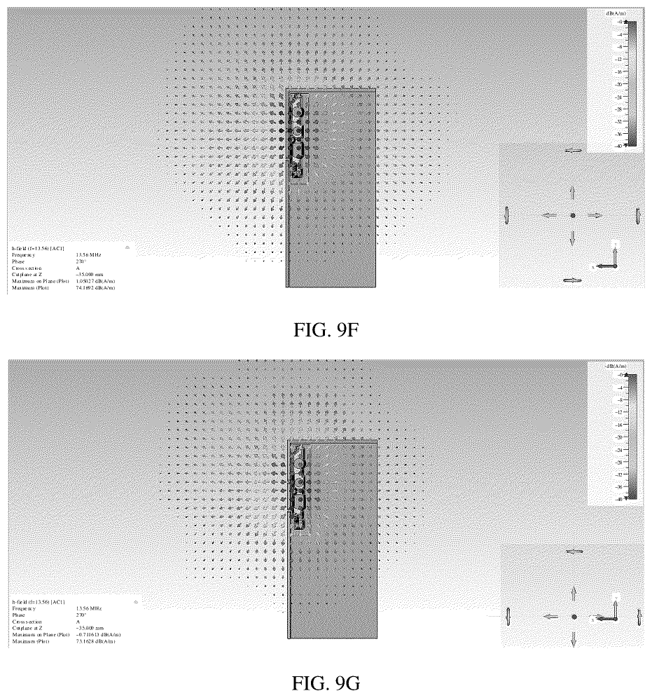

FIG. 9A to FIG. 9G are schematic diagrams of a group of simulation results of an NFC antenna and a conventional antenna.

FIG. 9A to FIG. 9C show sections of an NFC antenna 24 and a conventional antenna (schematic diagrams in which an antenna radiator is projected onto an XOY). A black plate-shaped region is the NFC antenna 24, and a left rectangular region is the conventional antenna 20x. In

FIG. 9A and FIG. 9B, a quantity M of the conventional antennas 20x is 4, and operating frequencies corresponding to the four conventional antennas are respectively 1.7 GHz to 3.8 GHz, 2.4 GHz to 2.5 GHz, 5 GHz, and 703 MHz to 960 MHz. An operating frequency of the NFC antenna 24 is 13.56 MHz. A gap distance L between the NFC antenna 24 and each of the four conventional antennas is 0.7 mm. In addition, a region below the NFC antenna 24 is a second middle frame 412.

In FIG. 9A, each conventional antenna 20x is grounded through a 100 pF capacitor (blocking device). In FIG. 9B, grounding terminals of the four conventional antennas 20x are directly grounded without being connected to any blocking device. In FIG. 9C, the conventional antenna 20x is removed, and only the NFC antenna performs radiation.

First, FIG. 9A is compared with FIG. 9B. After a direct current blocking capacitor is added to the conventional antenna 20x, a magnetic field (in a dashed-line box) in a lower left corner is significantly enhanced, and a magnetic flux absolute value and an induced voltage in space are effectively increased. This indicates that a radiation effect of the NFC antenna 24 is better after the capacitor is added. In addition, FIG. 9A is compared with FIG. 9C. After the conventional antenna is removed, and a left side is not shielded by metal, magnetic field strength is enhanced, an induced voltage is increased, and a radiation effect is good when the NFC antenna 24 is not shielded. In conclusion, it can be learned that, in an actual antenna assembling process of an electronic device, it is basically impossible to remove a conventional antenna. Therefore, a capacitor is added to the conventional antenna, so that a radiation effect of an antenna can be improved.

FIG. 9D and FIG. 9E are a group of simulated magnetic field patterns on an XOY plane according to an embodiment.

FIG. 9D is a magnetic field pattern that is on the XOY plane and that in which a gap distance L is 0.7 mm and a 100 pF capacitor (blocking device) is added to a conventional antenna. FIG. 9E is a magnetic field pattern that is on the XOY plane and that in which a gap distance L is 0.7 mm and a conventional antenna is directly grounded. It can be found through comparison that a magnetic flux area increases effectively (a dark region is larger) after the 100 pF capacitor is added.

FIG. 9F and FIG. 9G are another group of simulated magnetic flux patterns on an XOY plane. FIG. 9F is a magnetic flux pattern in which a gap distance Lis 0.7 mm and a 100 pF capacitor (a blocking device) is added to a conventional antenna. FIG. 9G is a magnetic flux pattern in which a gap distance L is 0.7 mm and a conventional antenna is directly grounded. It can be learned through comparison between FIG. 9F and FIG. 9G that, in FIG. 9F, a color is darker, a magnetic field signal is stronger, and a magnetic field area is larger. Therefore, an effect of adding the 100 pF capacitor is better.

It may be found through comparison between the simulation results in FIG. 9D to FIG. 9G that after the capacitor is added, a magnetic field area on the XOY plane increases, especially an area along an X-axis direction increases. This indicates that secondary radiation is generated nearby by the conventional antennas, so that a radiation effect of the NFC antenna is better.

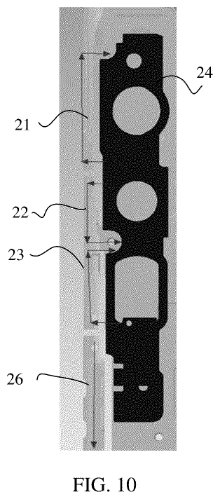

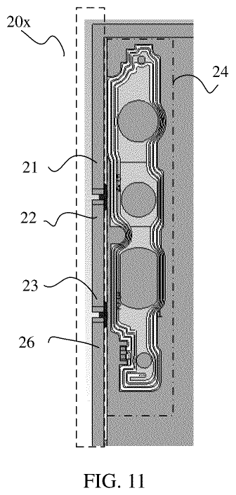

FIG. 10 is a schematic diagram of an electric field result of an NFC antenna and a conventional antenna according to an embodiment of this application. A part of an electronic device 100 may include an NFC antenna 24 and four (M) conventional antennas. A radiator of the NFC antenna 24 is in a sheet shape, and a first antenna 21, a second antenna 22, a third antenna 23, and a sixth antenna 26 included in the conventional antennas are sequentially arranged on a side of the NFC antenna 24. In FIG. 10, an electric field (a direction indicated by an arrow is an electric field direction) is formed between the NFC antenna and each of the first antenna 21, the second antenna 22, the third antenna 23, and the sixth antenna 26, so that the first antenna 21, the second antenna 22, the third antenna 23, and the sixth antenna 26 each generate secondary radiation on a signal of the NFC antenna, which is equivalent to increasing a width of the NFC antenna. In this way, an NFC card swiping success rate can be improved.

For different gap distances and blocking devices with different parameters, antenna radiation effects are different. To further compare effects of different gap distances and blocking devices with different parameters on the radiation effect, the following provides specific description by using simulation result data.

FIG. 11 is a schematic diagram of a simulation structure of an NFC antenna and a conventional antenna according to this embodiment. As shown in FIG. 11, a part of an electronic device 100 may include an NFC antenna 24 and M conventional antennas. In this case, a quantity M of the conventional antennas is 4, namely, a first antenna 21, a second antenna 22, a third antenna 23, and a sixth antenna 26, and operating frequencies corresponding to the four conventional antennas may be 1.7 GHz to 3.8 GHz, 2.4 GHz to 2.5 GHz, 5 GHz, and 703 MHz to 960 MHz respectively. An operating frequency of the NFC antenna 24 is 13.56 MHz, and a coil needs to be mounted around an NFC antenna radiator. In this case, a spatial rectangular coordinate system XYZ that uses a geometric center position of the NFC antenna radiator as an origin is established to perform simulation. Directions of the XYZ coordinate system are the same as those in FIG. 4 and in FIG. 5A to FIG. 5D. Details are not described herein again. In all the following simulation data tables, the geometric center position of the NFC antenna obtained through measurement is the origin O (usually, current density corresponding to the origin is the largest). A measurement position is a coordinate position on an XOY plane, and measurement ranges of both an X-axis and a Y-axis are −35 mm to 35 mm. Such a measurement range basically covers an effective radiation range of the NFC antenna. In addition, a gap distance between each of the four conventional antennas and the NFC antenna is equal to L. The following simulation results can represent magnetic field strength (ampere/meter) per square millimeter, and a unit is A/m*mm².

In simulation results in Table 1 to Table 3, the gap distance Lis 0.7 mm.

Table 1 is a simulation result of an NFC antenna corresponding to a case in which grounding blocking devices of all four conventional antennas are 100 pF capacitors.

TABLE 1

| | 35 | 25 | 15 | 0 | −15 | −25 | −35 |
|---|---|---|---|---|---|---|---|
| Y/X | mm | mm | mm | mm | mm | mm | mm |
| 35 mm | | | | 6.19 | | | |
| 25 mm | | 5.76 | | 8.85 | | 5.81 | |
| 15 mm | | | 9.61 | 10.91 | 9.54 | | |
| 0 mm | 5.22 | 8.51 | 10.89 | 12.28 | 10.89 | 8.46 | 5.17 |
| −15 mm | | | 9.58 | 10.93 | 9.46 | | |
| −25 mm | | 5.46 | | 8.6 | | 5.67 | |
| −35 mm | | | | 5.93 | | | |

Table 2 is a simulation result corresponding to a case in which grounding terminals of the four conventional antennas are suspended (equivalent to an NFC antenna 24 corresponding to a case in which the four conventional antennas do not exist around the NFC antenna).

TABLE 2

| | 35 | 25 | 15 | 0 | −15 | −25 | −35 |
|---|---|---|---|---|---|---|---|
| Y/X | mm | mm | mm | mm | mm | mm | mm |
| 35 mm | | | | 6.19 | | | |
| 25 mm | | 5.76 | | 8.85 | | 5.81 | |
| 15 mm | | | 9.61 | 10.91 | 9.53 | | |
| 0 mm | 5.22 | 8.51 | 10.89 | 12.27 | 10.89 | 8.46 | 5.16 |
| −15 mm | | | 9.58 | 10.93 | 9.46 | | |
| −25 mm | | 5.42 | | 8.6 | | 5.67 | |
| −35 mm | | | | 5.93 | | | |

Table 3 is a simulation result corresponding to a case in which the four conventional antennas are not connected to a blocking device.

TABLE 3

| | 35 | 25 | 15 | 0 | −15 | −25 | −35 |
|---|---|---|---|---|---|---|---|
| Y/X | mm | mm | mm | mm | mm | mm | mm |
| 35 mm | | | | 4.8 | | | |
| 25 mm | | 4.63 | | 6.76 | | 3.97 | |
| 15 mm | | | 7.49 | 8.63 | 7.2 | | |
| 0 mm | 4.89 | 7.15 | 8.98 | 9.84 | 8.32 | 5.99 | 3.67 |
| −15 mm | | | 8.28 | 8.74 | 7.32 | | |
| −25 mm | | 5.4 | | 7.21 | | 4.51 | |
| −35 mm | | | | 5.53 | | | |

The foregoing Table 1, Table 2, and Table 3 are compared. When L is 0.7 mm, a best simulation result (a central magnetic flux value) of a radiation position of the NFC antenna is 12.28 when all the grounding blocking devices of the four conventional antennas are 100 pF capacitors in Table 1: a best simulation result of a radiation position of the NFC antenna is 12.27 when the grounding terminals of the four conventional antennas are suspended in Table 2; and a best simulation result of a radiation position of the NFC antenna is 9.84 when the four conventional antennas are not connected to the blocking device in Table 3. Calculation is performed based on the central magnetic flux values. NFC antenna performance corresponding to a case in which the four conventional antennas directly return to a ground is approximately 19.8% lower than NFC antenna performance corresponding to a case in which grounding is performed through the 100 pF capacitor, and the performance corresponding to a case in which grounding is performed through connection to the 100 pF capacitor and performance corresponding to a case in which the grounding terminals of the four conventional antennas are suspended are basically the same. Therefore, it can be learned that when a distance between the NFC antenna and the conventional antenna in the electronic device 100 is relatively close, performing returning to the ground through connection to the capacitor can significantly improve a radiation effect of the NFC antenna. In this embodiment of this application, the central magnetic flux value may indicate a simulation result corresponding to a case in which X and Y are both zero (at the origin).

For different gap distances, an improvement effect of the NFC antenna is determined based on simulation results corresponding to whether grounding is performed through the blocking device.

When the gap distance L is 0.2 mm, a simulation result of the central magnetic flux value of the NFC antenna is 13.23 when all the grounded blocking devices of the four conventional antennas are the 100 pF capacitors: and a simulation result of the central magnetic flux value of the NFC antenna is 10.2 when the four conventional antennas are directly grounded. The central magnetic flux value results are compared. NFC antenna performance corresponding to a case in which grounding is performed through the 100 pF capacitor is 22.9% higher than NFC antenna performance corresponding to a case in which grounding is performed directly.

When the gap distance L is 0.7 mm, a simulation result of the central magnetic flux value of the NFC antenna is 12.28 when all the grounded blocking devices of the four conventional antennas are the 100 pF capacitors: and a simulation result of the central magnetic flux value of the NFC antenna is 9.84 when the four conventional antennas are directly grounded. The central magnetic flux value results are compared. NFC antenna performance corresponding to a case in which grounding is performed through the 100 pF capacitors is 19.8% higher than NFC antenna performance corresponding to a case in which grounding is performed directly.

When the gap distance L is 1.7 mm, a simulation result of the central magnetic flux value of the NFC antenna is 10.76 when all the grounded blocking devices of the four conventional antennas are the 100 pF capacitors: and a simulation result of the central magnetic flux value of the NFC antenna is 9.34 when the four conventional antennas are directly grounded. The central magnetic flux value results are compared. NFC antenna performance corresponding to a case in which grounding is performed through the 100 pF capacitors is 13.2% higher than NFC antenna performance corresponding to a case in which grounding is performed directly.

When the gap distance L is 3.7 mm, a simulation result of the central magnetic flux value of the NFC antenna is 9.63 when all the grounded blocking devices of the four conventional antennas are the 100 pF capacitors: and a simulation result of the central magnetic flux value of the NFC antenna is 8.97 when the four conventional antennas are directly grounded. The central magnetic flux value results are compared. NFC antenna performance corresponding to a case in which grounding is performed through the 100 pF capacitors is 6.8% higher than NFC antenna performance corresponding to a case in which grounding is performed directly.

When the gap distance L is 5.7 mm, a simulation result of the central magnetic flux value of the NFC antenna is 9.14 when all the grounded blocking devices of the four conventional antennas are the 100 pF capacitors: and a simulation result of the central magnetic flux value of the NFC antenna is 8.97 when the four conventional antennas are directly grounded. The central magnetic flux value results are compared. NFC antenna performance corresponding to a case in which grounding is performed through the 100 pF capacitors is 1.85% higher than NFC antenna performance corresponding to a case in which grounding is performed directly. In other words, grounding through the 100 pF capacitors basically does not affect NFC antenna performance.

When the gap distance L is 8.7 mm, a simulation result of the central magnetic flux value of the NFC antenna is 8.58 when all the grounded blocking devices of the four conventional antennas are the 100 pF capacitors: and a simulation result of the central magnetic flux value of the NFC antenna is 8.41 when the four conventional antennas are directly grounded. The central magnetic flux value results are compared. NFC antenna performance corresponding to a case in which grounding is performed through the 100 pF capacitors is 1.98% higher than NFC antenna performance corresponding to a case in which grounding is performed directly. In other words, grounding through the 100 pF capacitors basically does not affect NFC antenna performance.

The foregoing gap distances L are compared. As the gap distance increases, improvement of NFC antenna performance decreases. When the distance reaches 5.7 mm, even connection to the capacitor cannot improve NFC antenna performance. In addition, in consideration of interference of the NFC antenna to the conventional antenna, a distance should be maintained between the conventional antenna and the NFC antenna.

When the gap distance L is 0.7 mm, a simulation result of the central magnetic flux value of the NFC antenna is 9.84 when the four conventional antennas are directly grounded: a simulation result of the central magnetic flux value of the NFC antenna is 12.28 when the grounded blocking devices of the four conventional antennas are all the 100 pF capacitors: and a simulation result of the central magnetic flux value of the NFC antenna is 12.32 when the grounded blocking devices of the four conventional antennas are all 1000 pF capacitors. The central magnetic flux value results are compared. A capacitance increase basically does not affect NFC performance. The grounding through a large capacitor may be equivalent to disconnecting at 13.56 MHz, and may improve performance of the NFC antenna.

Similarly, when the gap distance Lis 0.7 mm, a simulation result of the central magnetic flux value of the NFC antenna is 10.43 when all the grounded blocking devices of the four conventional antennas are 1 nH inductors: a simulation result of the central magnetic flux value of the NFC antenna is 11.69 when all the grounded blocking devices of the four conventional antennas are 10 nH inductors. The grounding through a small inductor may be equivalent to conducting at 13.56 MHz, and is different from the connection manner of the large capacitor in that radiation performance of the NFC antenna is reduced.

In this embodiment of this application, in addition to a capacitor, the blocking device may alternatively be a band-pass circuit, a band-stop circuit, or a high-pass filter. In the foregoing condition of FIG. 11, when the gap distance L is 0.7 mm, each of the four conventional antennas is grounded through a band-pass circuit, and a simulation result of the central magnetic flux value is 12.27. In this case, the band-pass circuit is the circuit shown in FIG. 8A, and C1 is 100 pF, and L1 is 1 nH. When the gap distance L is 0.7 mm, each of the four conventional antennas is grounded through a band-stop circuit, and a simulation result of the central magnetic flux value is 12.26. In this case, the band-stop circuit is the circuit shown in FIG. 8B, and C2 is 820 pF, and L2 is 160 nH. The foregoing two types of circuits basically do not affect the central magnetic flux values in Table 1 and Table 2. Therefore, the simulation result indicates that both the band-pass circuit and the band-stop circuit can improve radiation performance of the NFC antenna.

The foregoing descriptions are merely some implementations of this application, but a protection scope of this application is not limited thereto. Any variation or replacement readily figured out by a person skilled in the art within the technical scope disclosed in this application shall fall within the protection scope of this application. Therefore, the protection scope of this application shall be subject to a protection scope of the claims.

1. An antenna system, wherein the antenna system comprises one near field communication (NFC) antenna and N conventional antennas, each of the N conventional antennas comprises a feed point, a grounding point, and a radiating branch, M conventional antennas in the N conventional antennas comprise blocking devices, an i^{th} antenna comprises an i^{th} radiating branch, an i^{th} feed point, an i^{th} blocking device, and an i^{th} grounding point, the i^{th} radiating branch is coupled to the i^{th} feed point, the i^{th} radiating branch is coupled to the i^{th} grounding point through the i^{th} blocking device, and the i^{th} antenna is any one of the M conventional antennas:
the blocking device is configured to block a radio frequency signal in a frequency band of the NFC antenna in the M conventional antennas, and N is an integer greater than or equal to M, and M is a positive integer; and
in an operating process of the NFC antenna, the M conventional antennas are within a field strength range of radiation of the NFC antenna.

2. The antenna system according to claim 1, wherein a gap distance L exists between the NFC antenna and the M conventional antennas, L is a shortest spatial distance between antenna radiators of the M conventional antennas and a radiator of the NFC antenna, and a gap distance between the i^{th} antenna and the NFC antenna is an i^{th} distance lᵢ.

3. The antenna system according to claim 2, wherein a range of L is 0.2 mm to 10 mm.

4. The antenna system according to claim 1, wherein the blocking device comprises one or more of a capacitor, a band-pass circuit, a band-stop circuit, and a high-pass filter.

5. The antenna system according to claim 4, wherein when the blocking device is a capacitor, a capacitance range of the capacitor is 1 pF to 10 nF.

6. The antenna system according to claim 1, wherein when an operating frequency band of the i^{th} antenna is above 2.4 GHz, a capacitance range of an i^{th} capacitor is above 3 pF: when an operating frequency band of the i^{th} antenna is 1.7 GHz to 2.4 GHz, a capacitance range of an i^{th} capacitor is above 10 pF: or when an operating frequency band of the i^{th} antenna is 700 MHz to 900 MHz, a capacitance range of an i^{th} capacitor is above 33 pF: and
the i^{th} capacitor is the i^{th} blocking device.

7. The antenna system according to claim 4, wherein when the i^{th} blocking device is a band-pass circuit, the band-pass circuit allows a signal in a frequency band above 500 MHz to pass through.

8. The antenna system according to claim 4, wherein when the i^{th} blocking device is a high-pass filter, the high-pass filter allows a signal in a frequency band above 500 MHz to pass through.

9. The antenna system according to claim 6, wherein when M is 4, the M conventional antennas comprise a first antenna, a second antenna, a third antenna, and a sixth antenna, an operating frequency band of the first antenna is 2.4 GHz to 2.5 GHz, an operating frequency band of the second antenna is 5 GHz, an operating frequency band of the third antenna is 703 MHz to 960 MHz, and an operating frequency band of the sixth antenna is 1.7 GHz to 3.8 GHz.

10. An electronic device, comprises an antenna system, wherein the antenna system comprises one near field communication (NFC) antenna and N conventional antennas, each of the N conventional antennas comprises a feed point, a grounding point, and a radiating branch, M conventional antennas in the N conventional antennas comprise blocking devices, an i^{th} antenna comprises an i^{th} radiating branch, an i^{th} feed point, an i^{th} blocking device, and an i^{th} grounding point, the i^{th} radiating branch is coupled to the i^{th} feed point, the i^{th} radiating branch is coupled to the i^{th} grounding point through the i^{th} blocking device, and the i^{th} antenna is any one of the M conventional antennas;
the blocking device is configured to block a radio frequency signal in a frequency band of the NFC antenna in the M conventional antennas, and N is an integer greater than or equal to M, and M is a positive integer: and
in an operating process of the NPC antenna, the M conventional antennas are within a field strength range of radiation of the NFC antenna.
